(19) United States
(12) Patent Application Publication
(10) Pub. No.: US 2001/0032271 A1
(43) Pub. Date: Oct. 18, 2001

(54) Method, device and software for ensuring path diversity across a communications network

(75) Inventor: David Ian Allen, Ottawa (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/748,391

(22) Filed: Dec. 27, 2000

Related U.S. Application Data
(60) Provisional application No. 60/191,885, filed on Mar. 23, 2000.
(60) Provisional application No. 60/191,889, filed on Mar. 23, 2000.

(51) Int. Cl. G06F 15/173

(52) U.S. Cl. 709/239; 370/351

(57) ABSTRACT

A method, device and software for ensuring path diversity across a communications network are disclosed. The method forms a digest of resources used in an initial, working, path is created as the initial path is established. This digest may be used during the formation of a subsequent, protection, path. Each node along the subsequent path can use the digest to ensure that resources are not common to the initial and subsequent paths. Conveniently, the digest may take the form of a Bloom filter that summarizes local information about resources known to each node along the initial path. The method lends itself for use in an MPLS compliant network or any connection oriented network such as an ATM, SONET or switched optical network.

### CROSS-REFERENCE TO RELATED APPLICATIONS

This application claims the benefits of U.S. Provisional Patent Application No. 60/191,889 filed Mar. 23, 2000, and U.S. Provisional Patent Application No. 60/191,885 filed Mar. 23, 2000, the contents of both which are hereby incorporated herein by reference.

### FIELD OF THE INVENTION

The present invention relates to networking protocols, and more particularly to a method, device and software for establishing diverse paths across a network that need not share common points of failure.

### BACKGROUND OF THE INVENTION

The desire to provide reliability of connections across communications networks has been appreciated for some time now. As such, network designs often provide for redundant paths across such networks, used in the event of failure.

For example, synchronous optical networks (“SONET”) and asynchronous transfer mode (“ATM”) networks include protection switching mechanisms used to provide 1:n or 1+1 redundancy for provisioned paths across SONET and ATM networks. In the event of a signal fail or signal degrade defect, traffic may be switched from a working path to a protection path. These protection schemes, however, are premised on a network administrator's ability to manually design the path layout and allocate network resources so that working and protection paths do not have a common point of failure. Properly designing such paths, is often complex and therefore costly and time consuming. Moreover, in view of this complexity, many protection schemes only provide for 1+1 or 1:1 redundancy, with a single physical protection path for each working path.

Modern network architectures, however, allow network protocols that provide protection switching to be carried on diverse networks, adhering to varied transport layer protocols (often distinct from those protocols providing protection switching). Moreover, paths across such networks may be established dynamically. As noted, however, protection paths are typically configured manually. Thus, existing methods of provisioning protection paths are typically not integrated into automated path establishment mechanisms.

Example transport networks may, for example, be wavelength division multiplexed (“WDM”) or dense wavelength division multiplexed (“DWDM”) optical networks, or internet protocol compliant networks. Paths across such networks may be established using protocols such as control mechanisms used in multi-protocol label switching (“MPLS”). At present, these mechanisms are generally unaware of the physical characteristics of the networks, across which paths are established. They operate only with knowledge specific to their network layer in the protocol stack. As such, protection paths and working paths may share common points of failure across the network, non-optimally. For example, working and protection paths can inadvertently be transported on the same physical portion of a network, using, for example, the same interfaces, the same cable conduits, or the same railway bridges. In a WDM or DWDM optical networks, working and protection paths could be carried as separate wavelengths across the same optical fiber, without the knowledge of the protection layer protocol.

As should now be apparent, a method to ensure sufficient path diversity across a network to ensure working and protection do not share common points of failure would be desirable.

### SUMMARY OF THE INVENTION

In accordance with the present invention, a digest of resources used in an initial, working, path is created as the initial path is established. This digest may be used during the formation of a subsequent, protection, path. Each node traversed during establishment of the subsequent path can use the digest when making path establishment decisions to ensure that resources that would be consumed by a specific path are not common to the initial and subsequent paths. Conveniently, the digest may take the form of a Bloom filter that summarizes local information about resources known to each node along the initial path. The method lends itself for use in an MPLS compliant network or any connection oriented network such as an ATM, SONET or a switched optical network.

Conveniently, if the paths are established at the edge of a protected path, an edge node may received the digest and use it to establish a protection path. The invention is particularly well suited in networks where paths are created using distributed path establishment and signaling algorithms, such as those used for MPLS, ATM switched virtual circuits or are proposed for switched optical networks.

In accordance with an aspect of the present invention, there is provided a method of establishing a subsequent path across a network to be used to transport traffic carried along an initial path in the event of a failure or signal degradation on the initial path. The method includes receiving a digest representative of resources used along the initial path, each of the resources along the initial path known by at least one node on the initial path; and establishing the subsequent path, using the digest so that the subsequent path may use resources distinct from the resources used along the initial path.

In accordance with another aspect of the invention, a method of forming a digest of information representative of network resources along a path, includes, at each node along said path, adding to said digest, an indicator of resources used by said path and known to that node.

In accordance with another aspect of the present invention, a network node along a path includes a processor operable to pass an indicator of resources used along the path, known to the network node to an adjacent node on the path.

In accordance with yet another aspect of the present invention, a node on a communications network is operable to establish a secondary path across the network. This secondary path is capable of carrying traffic carried along an initial path, in the event of a fault or signal degradation along the initial path. The node is operable to use a digest representative of resources used along the initial path in establishing the secondary path, with each of the resources along the initial path known by at least one node on the initial path, so that the subsequent path may be established using resources distinct from the resources used along the initial path.

In accordance with a further aspect of the invention, a computer readable medium stores processor executable instructions that when loaded at a node capable of establishing a path on a network, adapt the node to pass an indicator of resources used along an established path and known to the network node to an adjacent node on the established path.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of this invention:

FIG. 1 illustrates a communication network, including network nodes exemplary of an embodiment of the present invention;

FIG. 2 illustrates the format of a Bloom filter; and

FIG. 3 illustrates formation of a Bloom filter in establishing a path across the network of FIG. 1.

### DETAILED DESCRIPTION

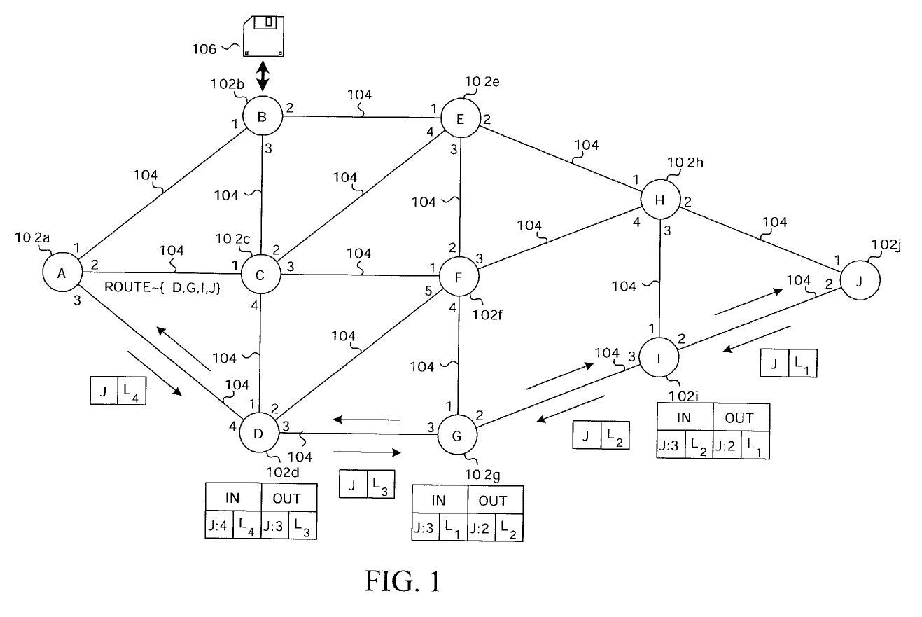

FIG. 1 illustrates a collection of network nodes 102a-102j (individually and collectively nodes 102), each exemplary of an embodiment of the present invention forming an exemplary communications network 100. Each of the network nodes 102 is in communication with at least one of the remaining nodes 102, by way of links 104. Links 104 may, for example, be fiber optic cables or other suitable physical links between nodes 102. Each physical link may be associated with a numbered port, as illustrated.

Each of nodes 102a-102j may be formed using a conventional network router, DWDM cross connect, ATM switch or the like. Each node is controlled by a processor under software control, allowing the establishment of paths or connections using, for example, existing path establishment protocols modified in manners exemplary of the present invention. Software including instructions that when executed by processors at each node, may be loaded from a computer readable medium, such a medium 106. Network nodes 102 may further support a network protocol, such as for example, the internet protocol (IP).

Nodes 102 on network 100 may be classified as originating nodes; intermediate nodes; or terminating nodes. For purposes of illustration, node 102a may be considered an originating node and node 102j as a terminating node. The remaining nodes may be considered intermediate nodes. Exemplary of the present invention, originating nodes establish an initial (or working) path and a subsequent (or protection) path between the originating and terminating nodes. Thereafter, the nodes on the path route traffic along the initial path between the originating and terminating node. The originating node is not necessarily the origin of information, but is the originator of the paths. Similarly, the terminating node is not necessarily the end point for information flow, but is the termination point for diverse paths. The originating and terminating node are said to be at the edges of a protection domain on the network. Other nodes (not illustrated) on network 100 may similarly act as originating and terminating nodes.

For example, network 100 may be an IP compliant network and support MPLS, as detailed in Eric C. Rosen et al., Multiprotocol Label Switching Architecture, Network Working Group, Internet Draft, <draft-ietfmpls-arch-06.txt>, August 1999 and R. Callon et al., A Framework for Multiprotocol Label Switching, Network Working Group, Internet Draft, <draftietf-mpls-framework-05.txt>, September 1999 to establish paths across the network. As will, however be appreciated, the invention may be used in other networks that are not IP compliant and that do not use MPLS. Instead, for example, the invention could be used in an ATM network, or in another network that allows edge established connections across the network.

Now, in a manner exemplary of the present invention, originating node 102a establishes a working path and a protection path across network 100. As will become apparent, a working path is initially established across the network. Thereafter, the protection path is established. The paths may, for example, be established as a result of receipt of a request from a computing device (not illustrated) in communication with originating node 102a. Once established, traffic may be carried on the working path and switched to the protection path in the event of failure, using a conventional protection switching mechanism that typically notifies the originating node 102a that a failure has occurred. For example, in an ATM network, working and protection paths may carry ATM VPC or VCC. Switching between working and protection channels may be effected in accordance with International Telecommunication Union (ITU-T) Recommendations I.630 and I.610.

In order to establish the working path, any signaling protocol suitable for path establishment supported by nodes 102 may be used. For example, any path establishment mechanism forming part of MPLS such as MPLS label distribution protocol (“LDP”), could be supported at nodes 102 and therefore be used. As will be appreciated, such mechanisms may be used to establish label switched paths (“LSP”s) across a network, such as network 100. Example MPLS mechanisms include the LDP, used to establish paths hop-by-hop, or the explicitly routed label switched path (“ER-LSP”), used to establish pre-determined paths across network 100. Similarly, MPLS constrained routing LDP (“CR-LDP”) or RSVP traffic engineering (“RSVP-TE”) could be supported by nodes 102 and could be used to establish paths across the network 100. Similarly, in the event network 100 is formed as an ATM network, nodes 102 could comply with ATM Forum SIG 4.0 specification in order to allow establishment of paths across the network.

As will be appreciated, using ER-LSP an originating node, such as node 102a, may choose a path to a desired destination node using information about the network topography available to it locally. Information about network topography may for example, be stored in a database (not shown) local to node 102a, or in communication therewith. Originating node 102a passes a label request message to a terminating node, such as example node 102j, including information regarding the desired path across the network. Typically, the information identifying a path across the network will include the routing identity of a plurality of nodes or hops from the originating node to the destination node. For example, the label request message request may identify nodes along the path by their IP addresses. As will be appreciated, the path information available to the originating node 102a and forming part of the label request message typically reflects the topographic view of available routes/nodes across the network. As will further be appreciated the path information available to node 102a may be hierarchically compressed. For example, routing information available at the node and provided by such routing protocols as OSPF (open shortest path first) represents information hierarchically. Some portions of the network do not completely advertise all the network topology details to neighboring portions, they advertise a condensed form. So even with network layer routing, each node may not have a detailed view of the entire network. As well, for any network of sufficient size, information available to node 102a may not be synchronized with the current network state.

Alternatively, a hop-by-hop label request message may be originated by originating node 102a. As will be appreciated, this hop-by-hop request may only identify a destination node, such as node 102j. Alternatively, the request could include some information indicating a preferred path such as a loose or strict source route. For example, the request could include an MPLS designated transit list. In any event, the hop-by-hop request is passed along multiple path fragments, until it arrives at node 102j. Once it arrives at destination node 102j, a confirmation message is passed to node 102a, retracing the original routing, and confirming path establishment to the intermediate nodes along the path.

Establishment of an exemplary explicit route label switched path across the network 100 is illustrated in FIG. 1. So, for example, an ER-LSP label request message may include identifiers of a route including nodes 102d, 102g, 102i and 102j (i.e. ROUTE=D,G,I,J). If the network is an IP compliant network, these identifiers may take the form of IP addresses of nodes D, G, I and J. This label request message is passed from node to node along the desired path. So, the example message would be passed from node 102d, 102g, 102i and 102j, as illustrated. Once the path establishment message arrives at the destination node 102j, a label and port are associated with the incoming path. As illustrated, the message arrives at node 102j at port 2. Thus, label L1 and port 2 are associated with the path at node 102j. This label is passed to the immediately upstream node along the established path (i.e. to node 102i) in a path acknowledgment message. At node 102i, a label is assigned to messages on the incoming port along the path. Further, a mapping of the incoming port and label to the outgoing port (i.e. the incoming port of the acknowledgment message) and received label are made, and stored at node 102i (i.e. port 3 | label L2 to port 2 | label L1). The incoming label is also passed upstream to node 102g, in a path establishment acknowledgment message. So at node 102g the acknowledgment message arrives at port 2; label L3 is associated; and a mapping of port 3 | label L3 to port 2 | label L2 is formed at node 102g, and stored. Again, the assigned incoming label L3 is passed to the immediately adjacent upstream node, node 102d along the established path. Similarly at node 102d, the label and port associated with the upstream acknowledgment message are associated with an incoming port and label. So at node 102d, port 4 | label L4 is mapped to port 3 | label L3. This process is repeated until a label is associated with each hop of the path. In the illustrated example, label port 3 | label L4 may be used at node 102a to dispatch messages to node 102j.

Once the path is established, a message bearing the label, when received on an incoming port at an associated node, is switched to an output port where a new label is associated with the message. Node 102a may thus pass a message to node 102j, simply by dispatching the message to the destination address of node 102j, using port 3, label L4. Each intermediate node 102d switches the incoming message and associated label to the outgoing port and label, so that the message follows the established path to node 102g.

In a manner exemplary of the present invention, a route digest containing information of physical resources used by an established path is also formed. This route digest may be constructed by passing information representative of physical resources used by each hop from the destination to the originating node, at each node. The digest may be formed as a Bloom filter. That is, each node along the established path adds local knowledge representative of physical resources used by the path to the digest, to be passed to an upstream node. Preferably, each node updates a Bloom filter appended to the MPLS path establishment confirmation message, passed upstream by each node.

The Bloom filter is passed from terminating node 102j as an information element appended to the MPLS path setup acknowledgement messages. In a manner exemplary of the present invention, each intermediate node 102i, 102g, and 102d receives the Bloom filter and adds information representing one or more tokens identifying the physical resources used at the node and possibly describing the link between that node and the downstream node. The tokens may, for example, identify one or more of the physical fibers, a wave length, a trench, or a shared length risk group and interface associated with each hop for the path. As will be appreciated by persons of ordinary skill, a shared risk link group (“SRLG”) is an administered identifier that may represent some collection of network components that share a common mode of failure. For example, a SRLG may be a trench through which several conduits of fiber run. Other physical resources may be similarly identified. Thus, the Bloom filter will cumulatively store all tokens associated with the path, so once the originating node receives its path establishment confirmation message, the associated Bloom filter will represent a complete condensed description of the established path across the network.

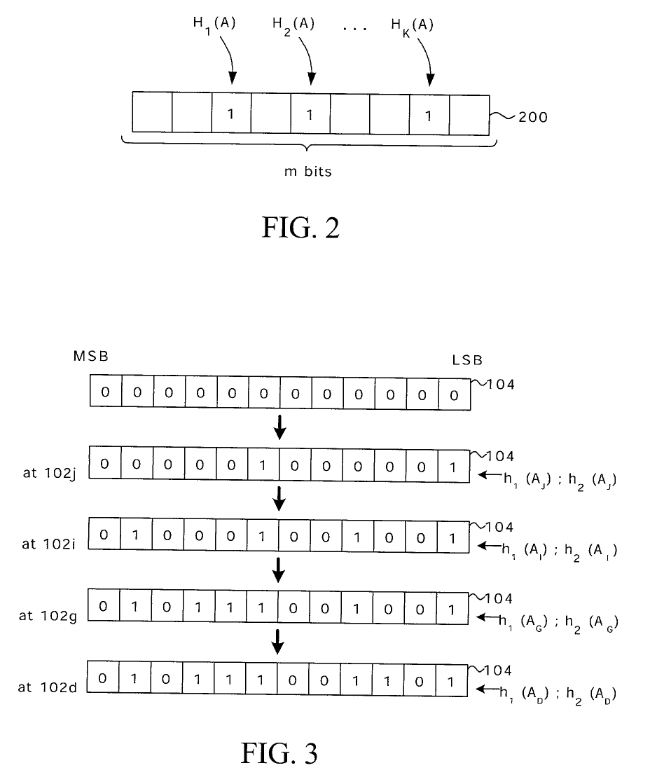

Bloom filters are known to those of ordinary skill in the art, and are for example, detailed in Burton Bloom, Space/time Trade-Offs in Hash Coding with Allowable Errors, Communications of the ACM, pages 13(7):422-426, July 1970. An example Bloom filter 200 is illustrated in FIG. 2. As is appreciated, a Bloom filter is a bitmap of m bits, used to represent n tokens A, each representing a resource. Each resource may be represented in filter 200 using k hash functions H1, H2 . . . Hk. Preferably, each hash function produces a single bit offset value defined as the hash value modulo the number of bits in the filter. This produces k bits to be set in the bitmap 200. k may be chosen to have a value of 1. To be of value, m is chosen to have a value less than n. At a later time, one may determine if a token A has been mapped into the Bloom filter, by calculating the k bits representing the token, and assessing if these bits are set within the Bloom filter. As should be appreciated, use of the Bloom filter only provides a probabilistic assessment of a token is contained in the filter. A Bloom filter, however, can provide an authoritative indication that a token is not contained in the filter. It may, for example, be illustrated that when a filter of length m already contains n tokens (each represented by k bits), a false positive will occur with a probability of approximately:

p(false_{—}positive)=(1−e^{kn/m})^{k}

As will thus be appreciated, use of a Bloom filter allows information about many network resources to be represented probabilistically in a relatively small bit map. Thus, testing a Bloom filter to determine if it contains a token provides a probable YES and an authoritative NO. As will become apparent, authoritative NO may be used as an authoritative test for route diversity.

So, although example network 100 has been illustrated to include a relatively few number of nodes, in reality a network using the present invention will have hundreds, thousands, or more nodes. Conveniently, a Bloom filter may be used to compress the route digest for paths across such a network into a bitmap of a fixed length field, in place of a token list of arbitrary length. Such a bitmap may represent an arbitrary amount of information and therefore facilities scaling the network.

The creation of an example route digest is illustrated in FIG. 3, representative of resources used in establishing the path illustrated in FIG. 1. As will be appreciated, in a manner exemplary of the present invention, nodes 102 are pre-configured with information about physical resources used by network hops passing through each node. Moreover, nodes 102 are configured with software used to modify a Bloom filter to contain indicators of these resources. An example Bloom filter having twelve bits is depicted. Moreover, two hash functions are used at each node. The hash functions used in the example are arbitrary. A person of ordinary skill will readily appreciate that more, fewer or other hash functions could be used at each node. Moreover, more or fewer bits could be used to form the Bloom filter.

As illustrated, node 102j begins with an empty bitmap and adds bits 0 and 6 associated with a resource at node 102j to the Bloom filter 104. The resource could be a physical fiber, a port or any other resource associated with the path from node 102i to 102j. Similarly, node 102i adds bits 3 and 10 associated with resource known to node 102i; node 102g adds bits 7 and 8; node 102d bits 2 and 11. It is worth noting that as bit 11 has already been set, it merely remains set as a result of node 102d. Ultimately, the Bloom filter having bits 0, 2, 3, 6, 7, 8, 9, and 11 is received at node 102a, as part of the path establishment confirmation message received from node 102d. This Bloom filter 104 when received at node 102a contains a route digest for the initially established path from node 102a to 102j across network 100. As will further be appreciated, each node could add indicators representative two or more resources at the node.

Once the Bloom filter for an initial path is constructed and received by the originating node 102a, node 102a may establish a secondary path in much the same manner as the first. In order to reduce likelihood that the secondary path shares resources (and therefore a common point of failure) with the initial path, originating node 102a may establish an explicit path having different routing nodes using MPLS ER-LSP. Alternatively, again, any other suitable path establishment mechanism may be used to establish the secondary path. So, for example, hop-to-hop LSR path establishment could be used.

Now, a path establishment request message for the second path may be accompanied with the route digest (in the form of the constructed Bloom filter) for the initial path, as well as an indicator that the path establishment message is establishing a protection path. Each node receiving this second path establishment message, along the subsequent path, may use local knowledge of resources used by hops to and from the node to assess overlap in these resources and the primary path to make routing decisions in manners exemplary of the present invention. Again, exemplary software at nodes 102 may adapt the nodes to make such a comparison. In the event there is overlap in the resources used, a node 102 may either choose different resources to complete the path or dispatch a message indicating that a desired path is inappropriate as it lacks diversity from the initial path.

For example, node 102a (FIG. 1) may establish a protection path, to node 102j using a modified LDP. Path establishment messages identifying node 102j, and containing an indicator that a protection path is being established, and a route digest of a working path are thus broadcast from node 102a to nodes 102b, 102c and 102d. At each node, the route digest associated with the path establishment message is compared to local knowledge about resources used at that node. This may be done by forming a separate Bloom filter containing a token associated with a potential path establishment decision, based upon local knowledge at a node, ANDing it with the route digest and XORing the result with the route digest. If the result is zero for any of the Bloom filters, the resource associated with the token in this Bloom filter have a high probability of overlap with resources used for the working path. If resources overlap, the node may test other alternative available resources at the node for use along the protection path.

So for example, each node 102 may be configured to store tokens that represent the interfaces, conduits, trenches (to whatever level of detail operator procedure) that using a particular interface of the node would involve. These tokens may be compared with the route digest. In this way, each network node can determine the impact on reliability of the subsequent path that use of a particular resource would have.

It is worth noting that a Bloom filter representing all resources at a node is not compared to the route digest. This result would be inconclusive. Accordingly, a Bloom filter representing each token is instead formed and individually tested against the route digest.

Ultimately if alternate resources at the node cannot be used, the path establishment message may simply be discarded, so that the eventually established secondary path does not include the node. Optionally, a message indicating the overlap may be passed back to the source of the path establishment message or upstream, such that the establishment of the subsequent path backs up one node along the node, as there is no viable path using the current node. So, in the example, node 102d may discard the message and/or notify node 102a accordingly. Similarly, any path establishment message received at node 102i from node 102g may be discarded. Alternatively, node 102i could pass a path establishment message upstream to node 102g, indicating that use of node 102i as part of the path is inappropriate. Node 102g, in response, may attempt to establish the path using node 102f.

As should now be appreciated, methods exemplary of the invention allow the establishment of two independent and diverse paths across a network of arbitrary size. The independent paths conveniently need not share a common point of failure. As such, failure or signal degradation along one path will likely not impact on the other path, allowing more effective redundancy and protection switching.

Similarly, although the invention has been described largely in the context of an MPLS compliant network, it may be easily be used with other connection oriented networks that permit an edge node to establish paths using signaling transactions. Example connection oriented networks include ATM networks or the automatically switched optical networks work in progress at the ITU (as for example detailed in ITU-T G.ason).

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

What is claimed is:

1. A method of establishing a subsequent path across a network to be used to transport traffic carried along an initial path in the event of a failure or signal degradation on said initial path, said method comprising:
receiving a digest representative of resources used along said initial path, each of said resources along said initial path known by at least one node on said initial path;
establishing said subsequent path, using said digest so that said subsequent path may use resources distinct from said resources used along said initial path.

2. The method of claim 1, wherein said digest comprises a Bloom filter representative of resources known to each of said nodes.

3. The method of claim 2, wherein said Bloom filter has a fixed number of bits, and may provides an authoritative indicator that a resource is used by said initial path.

4. The method of claim 3, further comprising adding information representing said resources along said initial path to said Bloom filter at each of said nodes.

5. The method of claim 1, wherein each of said nodes on said initial path contributes knowledge known thereat to form said digest.

6. The method of claim 4, wherein said initial path extends from an originating node to a terminating node on said network, and said digest is received at said originating node.

7. The method of claim 6, wherein said digest is received as a part of a message confirming establishment of said initial path.

8. The method of claim 7, wherein said establishing comprises providing said digest to each node along said subsequent path.

9. A method of forming a digest of information representative of network resources along a path, comprising
at each node along said path, adding to said digest, an indicator of resources used by said path and known to that node.

10. The method of claim 9, wherein said digest is a Bloom filter.

11. The method of claim 10, wherein said Bloom filter has a fixed number of bits, and may provides an authoritative indicator that a resource is used by said initial path.

12. The method of claim 10, wherein said path extends from an originating node to a terminating node, and wherein said digest is formed as confirmation of establishment of said path is passed from said terminating node to said originating node.

13. The method of claim 12, wherein said resources comprise physical resources used along said path.

14. The method of claim 13, wherein said resources comprise at least one of physical port and a physical interconnect used by said path.

15. A network node along a path, comprising a processor operable to pass an indicator of resources used along said path, known to said network node to an adjacent node on said path.

16. The network node of claim 15, configured with local knowledge of local resources used by paths including said network node.

17. The node of claim 16, wherein said node is further operable to
receive a digest of resources used along said path;
add said indictor to said digest;
and pass said digest to said adjacent node.

18. The node of claim 17, wherein said digest comprises a Bloom filter, and said node is operable to modify said Bloom filter to reflect said resources.

19. The node of claim 18, wherein said indicator is formed as said node acknowledges formation of said path.

20. The node of claim 19, wherein said path extends from an originating node to a termination node on said network, and said indicator is passed upstream towards said originating node along said path.

21. A node on a communications network operable to establish a secondary path across said network, said secondary path capable of carrying traffic carried along an initial path, in the event of a fault or signal degradation along said initial path, said node operable to use a digest representative of resources used along said initial path in establishing said secondary path, each of said resources along said initial path known by at least one node on said initial path, so that said subsequent path may be established using resources distinct from said resources used along said initial path.

22. Computer readable medium storing processor executable instructions that when loaded at a node capable of establishing a path on a network, adapt said node to pass an indicator of resources used along an established path and known to said network node to an adjacent node on said established path.
